(19) United States
(12) Patent Application Publication
(10) Pub. No.: US 2006/0293060 A1
(43) Pub. Date: Dec. 28, 2006

(54) Load balancing method for wireless communication systems

(75) Inventors: Weidong Yang, Plano, TX (US); John Grabner, Plano, TX (US); Guanghan Xu, Garland, TX (US); Hang Jin, Plano, TX (US); Hang Li, Allen, TX (US)

Correspondence Address: Howard Chen, Esq.;PRESTON GATES & ELLIS LLP, Suite 1700, 55 Second Street, San Francisco, CA, 94105, US

(73) Assignee: Navini Networks, Inc.

(21) Appl. No.: 11/244,973

(22) Filed: Oct. 5, 2005

Related U.S. Application Data
(60) Provisional application No. 60/692,721, filed on Jun. 22, 2005.

(51) Int. Cl. H04Q 7/20

(52) U.S. Cl. 455/453

(57) ABSTRACT

A method and system is disclosed for load balancing in a wireless communication system. The method has two major processes for load balancing purpose: the first process moves a mobile terminal from its host base station to some less loaded base station after the expiration of a switch time interval determined by the signal strength difference between the original host base station and the base station that the mobile terminal is moving to; the second process moves the mobile terminal from its host base station to the base station with the strongest signal strength periodically.

### CROSS REFERENCE

The present application claims the benefits of the U.S. Provisional Patent Application No. 60/692,721, which was filed on Jun. 22, 2005.

### BACKGROUND

The present invention relates generally to a communication system design, and more particularly to a method for determining load balancing among various base stations in the wireless communication system.

In a wireless communication system, a mobile terminal transmits and receives radio signals from an antenna connected to a base station, which services a cell of the wireless communication system. The base station is connected to a mobile switching system which is further connected to a telephone/data network. The base station converts between RF signals and telephonic/data signals to allow communication between the mobile terminal and other communication terminals somewhere else in the telephone/data network.

In a typical wireless communication system, the coverage areas of multiple base stations may overlap in order to ensure that there is a selected base station that can provide appropriate telephone service to a mobile terminal. Since there are concurrent services of multiple base stations, the mobile switching system must determine which base station provides service to the mobile terminal. In a conventional wireless system, the choice of the base station is determined by comparing the signal strength of signals between the mobile terminal and each base station involved. Usually, the base station that has the strongest signal strength for signals from the mobile terminal is assigned to provide service to the mobile terminal.

Since each base station must carry a plurality of mobile terminals, it is preferred that the load of the base station be evenly distributed among the base stations so no one base station is unduly overloaded. In short, load balancing is the method to achieve evenly distributed loads among base stations. If the load balancing is not appropriately designed, the quality of the service provided by the base station to the mobile terminal will be negatively impacted. The problem of load balancing is complicated by the different propagation conditions between the mobile terminals and base stations, and other operation related variables make load balancing even more difficult. For example, base stations may have different transmission powers, capacities, and coverage areas.

In implementing a load balancing mechanism, in general, one can consider either a centralized method or a distributed method. In the centralized method, the decision that one mobile terminal be moved from one base station to another base station is made by the base station. In the distributed method, the decision that one mobile terminal be moved from one base station to another base station is made by the mobile terminal. If the decision is made by the mobile terminal, the benefit is that the mobile terminal can measure the signal strength from multiple base stations, hence it has some idea about the path loss between those base stations and itself. Yet at the same time it is difficult for the mobile terminal to know the consequence of its moving from one base station to another in terms of base station loading.

If the decision is made by the base stations, the benefit is that the base stations can relatively easily find out the consequence of moving one mobile terminal from one base station to another, but it is difficult for base stations to know the path losses between base stations and a mobile terminal without feedback from the mobile terminal.

What is desired is an improved load balancing mechanism considering both path loss and base station loading.

### SUMMARY

In view of the foregoing, this invention provides a method for load balancing in a wireless communication system.

In one embodiment, the method has two major processes for load balancing purpose: the first process moves a mobile terminal from its host base station to some less loaded base station after the expiration of a switch time interval determined by the signal strength difference between the original host base station and the base station that the mobile terminal is moving to; the second process moves the mobile terminal from its host base station to the base station with the strongest signal strength periodically.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 illustrates a typical wireless communication system.

FIG. 2 is a chart illustrating a graphical relation between SYNC signal strength difference of a host base station and a candidate base station, and the switch time interval according to one embodiment of the present invention.

### DESCRIPTION

The present disclosure provides a method for implementing load balancing in wireless communication systems.

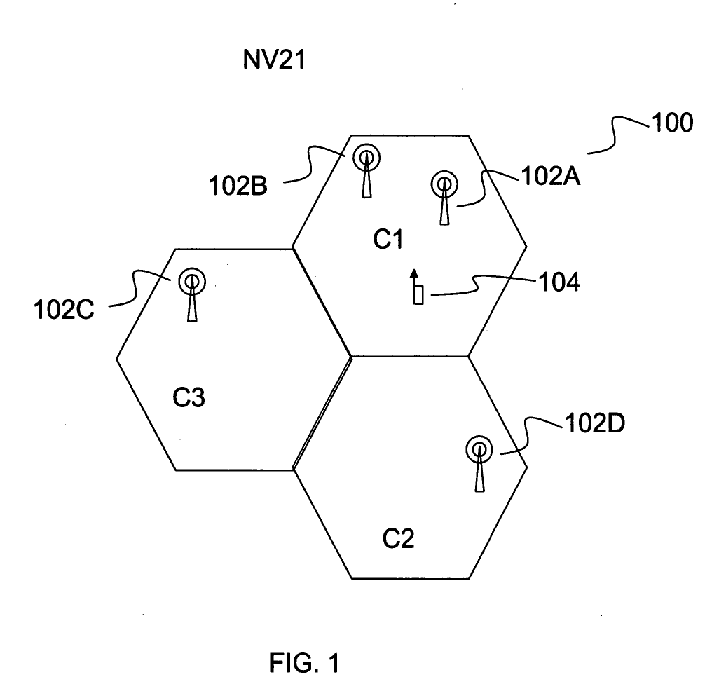

FIG. 1 illustrates a telecommunication system 100 deployed in the field for providing voice and data communications to one or more mobile terminals. For illustration purpose, only three cells C1, C2, and C3, are shown. Each cell has at least one base station 102A-102D that is responsible for communicating with all mobile terminals 104 within the boundaries of the cell. Each mobile terminal, no matter whether it is idle or in communication status, has a host base station. The mobile terminal 104, which is originally operating with a host base station in cell C1, may be under the coverage of another base station such as 102B. The host base station is normally the base station which is found to have a small (or even the smallest) path loss to the mobile terminal and has enough capacity to meet the mobile terminal's demand in terms of quality of service.

The disclosed method provides that the base station broadcasts load information such that each mobile terminal has relatively up-to-date information of the host base station loading as well as other base stations. For example, each base station can send its load information to its neighboring base stations, and the load information of other base stations in a certain base station's neighbor list will be broadcast along with that base station's load information. If each base station broadcast its' own and its neighbors' load information, then one mobile terminal needs to read only the load information from the mobile terminal's host base station's broadcast. On the other hand, if each base station broadcasts just its own load information, then one mobile terminal has to find the load information of each base station from that base stations' broadcast one by one. The load information is determined based on available uplink bandwidth, available downlink bandwidth and a number of mobile terminals associated with the base station.

Each mobile terminal can also check the signal strength of the base stations such that each mobile terminal has the relatively accurate information of signal strength from each base station. A further possibility is that the mobile terminal can find the loading of base stations from a combination of above stated approaches. It is understood that the load information can be designed in the form of a load factor. For example, the load factor can be a number representing a selected set of load information items such as the number of registered users at the base station, available uplink bandwidth, and available downlink bandwidth. Those load information items should be averaged over multiple frames to reflect the averaged load of a base station.

From the perspective of minimizing multi-cell interference, it is preferred that the base station that has the strongest signal strength among all the base stations operating at the same frequency or the same set of frequencies should be the host base station for a particular mobile terminal. Therefore, each mobile terminal needs to constantly monitor the signal strength of all base stations of interest in order to balance the need of reducing the multi-cell interference and managing the load sharing among the various base stations.

In a downlink frame of a certain wireless communication system, a control signal such as a SYNC signal is transmitted by a base station at a constant power. Base stations can have different SYNC signals, while the mobile terminals can find the SYNC signals through correlation. The SYNC signal is one way for the mobile terminal to measure the signal strength or path loss with regard to a particular base station. The present invention provides various ways to manage the load of base stations with the consideration of the multi-cell interference. For the discussion below, there are a set of control parameters or variables which will be used and they are listed in Table I below.

TABLE I

| Time interval | Description | Sample Value |
|---|---|---|
| T_{NSCAN}_Idle | Time period for | 5 minutes |
| | Neighbor SYNC Scan | |
| T_{NSCAN}_TIME | Time period a mobile | 30 ms |
| | terminal takes to | |
| | sample SYNC on a | |
| | neighbor base station | |
| T_{base station}_SHARE_TIME | Time period over | 5 seconds |
| | which the base | |
| | stations share with | |
| | each other load | |
| | information | |
| T_{Go}_strongBTs | Minimum time | 90 minutes |
| | period that a mobile | |
| | terminal will use to | |
| | come back to the base | |
| | station with the best | |
| | SYNC regardless of | |
| | its load | |
| L_{Historisis} | Historicis for | 10% |
| | considering a base | |
| | station less loaded | |
| T_{NEIGHBOR}_TIME | Time period over | 1 second |
| | which the neighbor | |
| | list is broadcasted to | |
| | the mobile terminals | |
| | from the host base | |
| | stations | |
| BITless_loaded | Parameter indicating | On or off |
| | the candidacy of a | |
| | base station | |
| T_{SWITCH} | Switch time interval | varies |
| | during which the | |
| | mobile terminal is not | |
| | allowed to switch to | |
| | another base station | |

According to one example of the present invention, every base station delivers to each of its neighboring base stations the load information in every T_{base station}_{_{—}}_{SHARE}_{_{—}}_{TIME}. The base station load information can be communicated to the neighboring base stations via the Inter-base station Messaging Protocol. Since each base station is supposed to receive from each of its neighboring base stations the load information. If the load information for a certain neighbor base station is not received for several consecutive T_{base station}_{_{—}}_{SHARE}_{_{—}}_{TIME} periods of time, the base station considers this neighbor as overloaded.

The base station then determines if a neighboring base station is less loaded and hence is a candidate for taking over some load from it. If the load of a neighbor base station is less than a first predetermined threshold such as a value equal to (host base station load*(1−L_{Historisis})), then that neighbor base station is marked as available to take over load from this base station's perspective. If so, a predetermined parameter indicating the candidacy of this neighbor base station, BITless_loaded, is set. If the load of the neighboring base station is more than a second threshold such as a value equals to (host base station load*(1+L_{Historisis})), then this neighboring base station is considered more heavily loaded and not a candidate to take over load. If the load of the neighboring base station is between the first and second thresholds, the load sharing status of this base station is going to be maintained. This two-threshold mechanism prevents mobile terminals from toggling back and forth among base stations if those base stations are similarly loaded. The candidate base station can also be determined based on path loss of the communication between each base station and the mobile terminal. Ideally, the candidate base stations should have a relatively small path loss comparing to others using the same frequency. A threshold can be set to filter certain large path loss base stations. A candidate list is then compiled, which is a list of neighboring base stations of a host base station, which are qualified to be candidates for taking loads from the host base station. The candidate list is broadcast to the mobile terminals every T_{NEIGHBOR}_{_{—}}_{TIME}.

On each mobile terminal, the mobile terminal achieves time, frequency and frame synchronization with a selected host base station, and the mobile terminal needs to decode successfully the broadcast message from that base station. The mobile terminal periodically receives from the host base station the candidate list update message, which is used by the mobile terminal to make decisions to switch to another base station based on the algorithm described below.

When the mobile terminal is not in a call or data session, for every time interval of T_{NSCAN}_{_{—}}_{Idle}, the mobile terminal tunes to one base station on the host base station neighbor list who has a subset of base stations whose BITless_loaded is set, and checks its SYNC signal for T_{NSCAN}_{_{—}}_{TIME}. This allows the mobile terminal to determine the SYNC signal strength with a multipath profile. This step is repeated for all the neighboring base stations that are the load sharing candidates in the candidate list of the host base station. A candidate base station with the best SYNC signal and with a signal-to-noise ration (SNR) larger than a threshold value such as 10 dB is identified. A timer T_{SWITCH} that represents the switching interval for this base station is started. The search for the next best load sharing candidate continues to perform while this timer counts down before the end of the T_{NSCAN}_{_{—}}_{Idle}. If before the current timer T_{SWITCH} expires, a different base station is later identified as the one having a better quality of SYNC signal and having a smaller Tswitch than the remaining time of the current Tswitch, then the timer T_{SWITCH} is restarted for this better base station. So, within T_{NSCAN}_{_{—}}_{Idle}, the mobile terminal finally finds a candidate and switches over. The T_{SWITCH} time then functions like a “lock time” during which the mobile terminal is not allowed to switch.

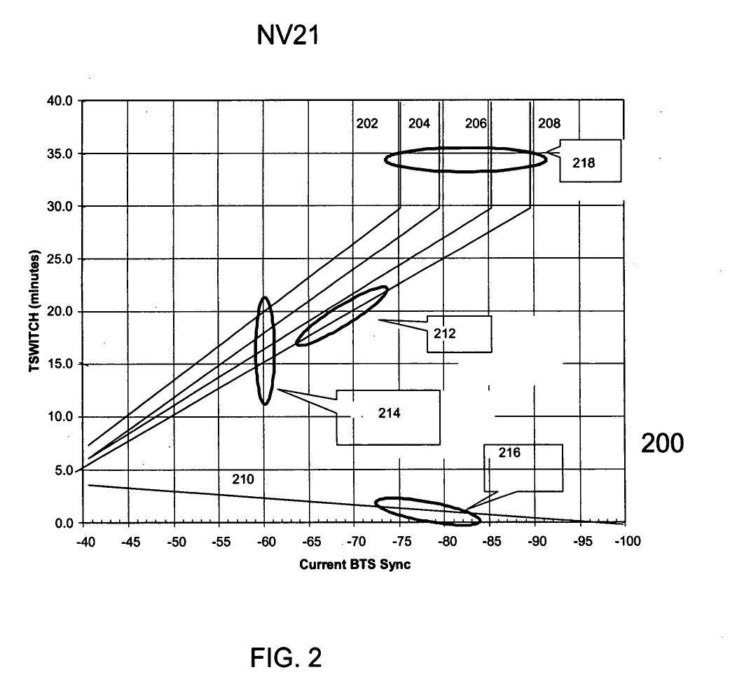

The final T_{SWITCH} is found based on the relative strength of the SYNC signals of the host base station and the candidate base station. More specifically, the signal strength difference between the host base station and the candidate base station is considered. FIG. 2 illustrates a chart 200 with a few samples for determining the relation between the strength of the SYNC and the switch interval. In FIG. 2, five sample lines 202-210 representing five different situations are shown. These five different lines are different due to their relative signal strength of the SYNC signal with regard to the SYNC signal of the host base station. From line 202 to line 210, their positions sequentially migrate from the left to right and top to bottom of the chart. In this example, it is assumed that only line 210 represents a base station that has a better SYNC signal strength than the host base station. The other four lines all represent situations in which the signal strength of the SYNC signal of the host base station is better than one from the candidate base station, with line 202 representing the worst and line 202 representing the best among four of them. For instance, line 208 represents the candidate base station having a weaker SYNC signal strength than that of the host base station by 5 dB, line 206 represents the candidate base station having a weaker signal strength than the host base station by 10 dB, line 204 represents the candidate base station having a weaker signal strength than the host base station by 15 dB, and line 202 for the candidate base station having a weaker signal strength than the host base station by 20 dB.

The switch interval T_{SWITCH} will be determined by considering the relation between the strength of the SYNC signal of the host base station and the candidate base station. When the candidate base station has a better signal strength, generally speaking, the worse the signal strength of the host base station, the shorter the switch interval is. For instance, in the area identified by circle 216, if the signal strength of the host base station is at −80 dB, the switch interval will be close to 0 minute, and if it is at −75 dB (which indicates that it is a better signal), the switch interval is set at a longer period. This indicates that a mobile terminal having a “not-so-great” relation with its current host base station should be moved quickly to another candidate base station that has a better signal strength.

In the area identified by circle 218 where the host base station has a SYNC signal strength less than −75 dB, the switch intervals are very large (e.g., above 30 minutes), and they are almost at the same level regardless of their relative signal strength with the host base station. This indicates that when the host base station takes a lot of energy to communicate with the mobile terminal, and the signal strength is still not necessarily at a desirable level, it is undesirable to let this mobile terminal to switch to a candidate base station that has an even weaker signal strength. Had the mobile terminal been allowed to switch without discrimination, it would just have added operational cost to the system since it would have switched to another base station very soon. It would be better to “lock” the mobile terminal with the host base station for a relatively long time.

If the candidate base station has a lower SYNC signal strength than the host base station, the switch time interval is partially dependant on the signal strength of the host base station. If the host base station has a better signal strength, it would have a shorter switch time interval. Circle 212 indicates that situation. For example, if a host base station has a signal strength of −70 dB, it would have a switch time interval of about 20 minutes. If the host base station has a better signal strength (e.g., −65 dB), the switch time interval would be shorter than 20 minutes.

Lastly, the switch time interval is longer for a weaker candidate base station among several candidate base stations. For instance, as indicated by circle 214, if the host base station is at −60 dB, and the switch time interval for a candidate base station 5 dB lower than the host would be around 15 minutes, but for a candidate base station 20 dB lower, it would be around 20 minutes.

The above rules determine how a mobile terminal should move from one host base station to another in order to have load sharing control. By setting the duration of the switch time interval, ideally, the mobile terminal from its original host base station to a less loaded base station after the expiration of such a timer. As shown above with regard to FIG. 2, the switch time interval is controlled by the signal strength difference between the host base station and the candidate base station. This process will allow base stations with overlapping coverage to share the load of mobile terminals. However, this process can also cause multi-cell interference as the mobile terminal may not be associated with the base station that has the strongest signal strength. To compensate this shortcoming, a second process is implemented to set up a second timer referred to as T_{Go}_{_{—}}_{strongBTS}. This process intends to put the mobile terminal under the host base station that has the strongest signal strength every once a while. For example, every T_{Go-StrongBTS} a mobile terminal that has moved to a less loaded base station will switch to the base station with the best SYNC signal strength regardless of its load condition. This will naturally increase the load of that particular base station, which makes that base station “less attractive” and may drive away some mobile terminals from that base station. The initiation of this move can be driven by the mobile terminal as well as the base station. For example, after the power-on process of the mobile terminal, the mobile terminal can set an internal T_{Go}_{_{—}}_{StrongBTS} timer to initiate its move to the base station that has the strongest signal strength at the time. Similar, once a base station becomes the host base station of the mobile terminal, it can also set up this time from the base station end.

With the careful choice of various timers such as T_{Go}_{_{—}}_{StrongBTS} and T_{SWITCH}, the load balancing can be implemented while minimizing multi-cell interference.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for balancing loads among a plurality of base stations in a wireless communication system, the method comprising:
notifying load information of a host base station to at least one mobile terminal under its coverage;
switching the mobile terminal to a candidate base station under a control of one or more control parameters including as least one timer representing a switch time interval whose length is determined according to a predetermined set of rules based on a comparison of a signal strength of a control signal received by the mobile terminal from the host and the candidate base station; and
periodically moving the mobile terminal to a selected base station with the strongest signal strength of the control signal regardless of its load situation.

2. The method of claim 1, wherein the notifying further includes broadcasting the load information to one or more mobile terminals associated with the host base station including load information for its neighboring base stations.

3. The method of claim 1, wherein the notifying further includes notifying the mobile terminal one or more neighboring base stations whose load is less than the host base station.

4. The method of claim 2, wherein the notifying further including determining whether one or more neighboring base stations have less load than the host base station.

5. The method of claim 4, wherein the determining further includes deploying a two-threshold mechanism so that base stations having load lower than a relatively lower threshold is deemed as a candidate base station for load sharing, while base stations with load above a relatively higher threshold are deemed no suitable for load sharing, and base stations with load between the two thresholds maintain their current load sharing status.

6. The method of claim 1, wherein the candidate base station that the mobile terminal switches to has a signal to noise ratio higher than a predetermined threshold.

7. The method of claim 1, wherein the predetermined set of rules includes, while the signal strength of the control signal received from the candidate base station is better than that from the host base station, setting the switch time interval based on the signal strength of the control signal so that the weaker the signal strength the shorter the switch time interval.

8. The method of claim 1, wherein the predetermined set of rules includes, while the signal strength of the control signal received from the candidate base station is worse than that from the host base station, the length of the switch time interval is in a predetermined relation with regard to the signal strength of the control signal of the host base station such that the better the signal strength the shorter the switch time interval.

9. The method of claim 1, wherein the predetermined set of rules includes, while the signal strength of the control signal received from the candidate base station is worse than that from the host base station, the length of the switch time interval with regard to a difference between the signal strength of the control signal of the host base station and that of the candidate base station is such that the bigger the difference the longer the switch time interval.

10. The method of claim 1, wherein the switching and periodically moving are performed when the mobile terminal is not in a voice or data session.

11. The method of claim 1, wherein the periodically moving is driven by either the mobile terminal or the host base station.

12. The method of claim 1, wherein the load information is determined based on available uplink bandwidth, available downlink bandwidth and a number of mobile terminals associated with the base station.

13. The method of claim 1, wherein the control signal is transmitted with a constant power from the base station.

14. A method for balancing loads among a plurality of base stations in a wireless communication system when the mobile terminal is not in a voice or data session, the method comprising:
notifying load information of a host base station to at least one mobile terminal under its coverage and a list of candidate base stations with a less load than the host base station and with a signal to noise ratio higher than a predetermined threshold;
switching the mobile terminal to a candidate base station under a control of one or more control parameters including at least one timer representing a switch time interval whose length is determined according to a predetermined set of rules based on a comparison of a signal strength of a control signal received by the mobile terminal from the host and the candidate base station; and
periodically moving the mobile terminal to a selected base station with the strongest signal strength of the control signal regardless of its load situation.

15. The method of claim 14, wherein the predetermined set of rules includes:
while the signal strength of the control signal received from the candidate base station is better than that from the host base station, setting the switch time interval based on the signal strength of the control signal so that the weaker the signal strength the shorter the switch time interval; and
while the signal strength of the control signal received from the candidate base station is worse than that from the host base station, the length of the switch time interval is in a predetermined relation with regard to the signal strength of the control signal of the host base station such that the better the signal strength the shorter the switch time interval.

16. The method of claim 15, wherein the predetermined set of rules includes, while the signal strength of the control signal received from the candidate base station is worse than that from the host base station, the length of the switch time interval with regard to a difference between the signal strength of the control signal of the host base station and that of the candidate base station is such that the bigger the difference the longer the switch time interval.

17. The method of claim 14, wherein the periodically moving is driven by either the mobile terminal or the host base station.

18. The method of claim 14, wherein the load information is determined based on available uplink bandwidth, available downlink bandwidth and a number of mobile terminals associated with the base station.

19. A method for performing load balancing among a plurality of base stations on a mobile terminal in a wireless communication system when the mobile terminal is not in a voice or data session, the method comprising:
receiving load information of a host base station by at least one mobile terminal under its coverage and a list of candidate base stations with a less load than the host base station and with a signal to noise ratio higher than a predetermined threshold;
switching to a candidate base station under a control of one or more control parameters including as least one timer representing a switch time interval whose length is determined according to a predetermined set of rules based on a comparison of a signal strength of a control signal received by the mobile terminal from the host and the candidate base station; and
periodically moving to a selected base station with the strongest signal strength of the control signal regardless of its load situation.

20. The method of claim 19, wherein the predetermined set of rules includes:
while the signal strength of the control signal received from the candidate base station is better than that from the host base station, setting the switch time interval based on the signal strength of the control signal so that the weaker the signal strength the shorter the switch time interval; and
while the signal strength of the control signal received from the candidate base station is worse than that from the host base station, the length of the switch time interval is in a linear relation with regard to the signal strength of the control signal of the host base station such that the better the signal strength the shorter the switch time interval.

21. The method of claim 19, wherein the predetermined set of rules includes, while the signal strength of the control signal received from the candidate base station is worse than that from the host base station, the length of the switch time interval with regard to a difference between the signal strength of the control signal of the host base station and that of the candidate base station is such that the bigger the difference the longer the switch time interval.

22. The method of claim 19, wherein the load information is determined based on available uplink bandwidth, available downlink bandwidth and a number of mobile terminals associated with the base station.
